(19) United States
(12) Patent Application Publication
(10) Pub. No.: US 2025/0258313 A1
(43) Pub. Date: Aug. 14, 2025

(54) MAPPING METHOD FOR THE STATUS INSPECTION AND/OR GEOLOCATION OF AN UNDERGROUND, SEMI-UNDERGROUND OR SUBMERGED STRUCTURE COMPRISING A METALLIC OR MAGNETIC MATERIAL

(71) Applicant: SKIPPER NDT, PAU (FR)

(72) Inventors: Laichoubi Mehdi, Paris (FR); Bénet Vincent, Fuveau (FR); Kella Bennani Hamza, Le Plessis Robinson (FR); Hu Miaohang, Bussy-Saint-Georges (FR); Stasse Florian, Meudon (FR); Takillah Samir, Boulogne Billancourt (FR)

(21) Appl. No.: 19/046,585

(22) Filed: Feb. 6, 2025

(30) Foreign Application Priority Data
Feb. 8, 2024 (FR) 2401260

(51) Int. Cl. G01V 3/38; G01V 3/08; G01V 3/165

(52) U.S. Cl. CPC G01V 3/38; G01V 3/081; G01V 3/165

(57) ABSTRACT

The present invention relates to a mapping method for the status inspection and/or geolocation of an underground, semi-underground or submerged structure including a metallic or magnetic material. The method includes acquiring spatial magnetic data obtained by magnetic sensors at different measuring points of the area to be inspected, after injecting a current onto the structure. A provisional segment is generated, including a provisional set of points, and a volume around each provisional point, the volume including a point cloud. A simulation is performed for each point of each volume, making it possible to calculate the simulated magnetic values of the cloud points at all or some of the measuring points.

### TECHNICAL FIELD

The present invention relates to a mapping method for the status inspection and/or geolocation of an underground, semi-underground or submerged structure including a metallic or magnetic material. The invention will find its application in the location of pipeline type pipes, in particular for liquid or gas transfer. The invention may also be used for the detection and geolocation of other types of structures or in geophysics type research. The invention may also be used in the external inspection of structures both for inspecting the integrity of the structure and for evaluating the magnetic connection between two nearby structures.

### TECHNOLOGICAL BACKGROUND

Various detection methods using magnetometers for the detection of non-visible structures as well as various associated methods are known.

Methods using various technologies such as radiodetection, radar and lidar are also known. In each of these different known techniques, measurements are made, in particular by scanning the sector to be inspected, then generating a 2D or 3D geolocation map from the data collected combining the measurements and the positioning of the measurements. For the generation of these maps, measurement anomalies originating from various causes and in particular the failure of a sensor or interference due to nearby structures are not always checked. Hence, these generated maps generally lack precision and may also contain aberrations.

The applicant filed an application WO2023148057 making it possible to overcome part of the aforementioned disadvantages. In this application, a method generating an interactive magnetic map from the collected magnetic data is provided. Using this interactive magnetic map, an operator can add or delete magnetic data to correct detection anomalies or to interpolate data according to nearby magnetic data. In the method described in this application, the data and the successive processing or filtering make it possible to provide good results in most cases, however, this method requires human intervention to correct a certain number of anomalies. This operator intervention requires good experience and is time-consuming. Furthermore, this type of method does not automatically invalidate incorrect or inconsistent structure plotting or positioning, whether the source of these plotting errors is from the magnetic data collected or from a poor choice of model. This type of method likewise cannot be used to compare actual data with data from simulation models.

### TECHNICAL PROBLEM TO BE SOLVED

A technical problem addressed by the present invention is that providing a new mapping method wherein the magnetic data are compared to simulated data making it possible to improve structure location precision.

Another problem addressed by the present invention is that of providing a method for verifying and/or correcting the results obtained from the simulation and collected data without human intervention.

Another problem addressed by the present invention is that of preventing generation of the geolocation map in the event of inconsistency or aberration.

Another problem addressed by the present invention is that of providing a method that is simple to implement and makes it possible to test several hypotheses until a consistent geolocation map is obtained.

### SUMMARY

The present invention relates to a mapping method for the status inspection and/or geolocation of an underground, semi-underground or submerged structure including a metallic or magnetic material, this method comprises the steps described hereinafter.

The mapping method comprises a step of acquiring spatial magnetic data obtained by magnetic sensors at different measuring points of the area to be inspected, after injecting a current onto the structure.

The method further comprises a step of generating a provisional segment, including a set of provisional points (Pi), and a volume (Vi) around each provisional point (Pi), the volume (Vi) including a point cloud.

The method further comprises a simulation step, for each point of each volume (Vi), making it possible to calculate the simulated magnetic values (VMS) of the cloud points at all or some of the measuring points (Pm).

The method further comprises a step of comparing the simulated magnetic values (VMS) of the cloud points of each volume (Vi) and spatial magnetic values (VM) to assign a score to each cloud point of each volume (Vi),

The method further comprises a step of selecting, for each volume (Vi), a point of the cloud having the best score, the set of selected points (Si) replacing the set of provisional points (Pi) of the provisional segment.

The method further comprises a step of creating a magnetic map containing the set of selected points (Si).

### DEFINITIONS

According to the present invention, the term magnetic or metallic material, in this application, refers to any type of conductive material generating a magnetic field after injecting a current, and in particular includes ferromagnetic type materials.

According to the present invention, the expression point cloud, in this application, refers to an unlimited set of points distributed in an orderly or random manner in a volume.

### BRIEF DESCRIPTION OF THE FIGURES

Other features and advantages of the present invention will become apparent from the description of the particular and non-limiting embodiments of the present invention hereinafter, with reference to appended FIGS. 1 to 4, wherein:

FIG. 1 schematically illustrates part of the steps of the method according to the invention,

FIG. 2 schematically illustrates an example of a plot generated by implementing the method according to the invention,

FIG. 3 represents an example of a map obtained by implementing the method according to the invention,

FIG. 4 represents an example embodiment of the method in diagram form containing the different steps of the method according to the invention.

### DETAILED DESCRIPTION

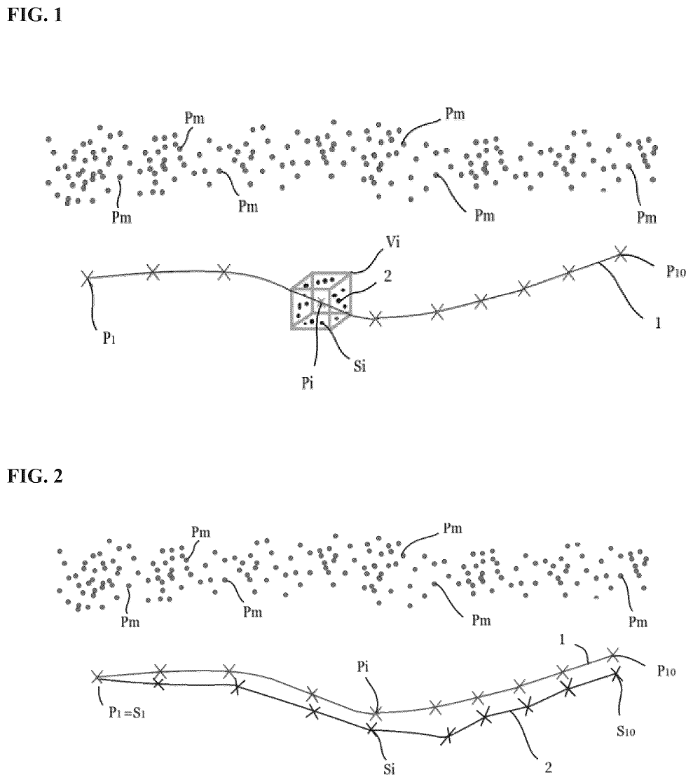

FIG. 1 illustrates different steps of the method in a general way. More specifically, the method comprises a step of acquiring spatial magnetic data obtained by magnetic sensors at different measuring points of the area to be inspected, after injecting a current onto the structure. These measuring points are represented schematically by the set of points Pm in the upper section of FIG. 1.

The example of FIGS. 1 and 2 is a simplified example, it therefore comprises a limited number of measuring points Pm at mean altitudes, this being the measurement principle and the method steps are identical for dealing with an actual case even if the number of measurements is greater.

The magnetic measurement of the measuring points is advantageously carried out by magnetometers in particular placed on a movable device such as a vehicle or an aircraft and in particular by a drone equipped with magnetometer ramps. The movable device moves in vertical alignment with the area to be inspected advantageously according to bands substantially parallel with the assumed positioning of the underground structure or according to a grid.

When the measuring points Pm have been obtained, the magnetic data can be processed to be able to be compared in subsequent steps of the method.

According to a first example, in order to be able to collect the magnetic data, a step of injecting a current into the structure and a step of processing the signal, the electrical component of the signal emitted by the structure in response to the injection of the signal allowing comparison with the simulated magnetic values are performed.

According to a second advantageous example, this step of acquiring the spatial magnetic data comprises a step of injecting an alternating current into the structure and a step of processing the magnetic measurements via a bandpass filter and a Hilbert filter.

The method then comprises a step of generating a provisional segment, including a set of provisional points Pi. In the simplified example, the provisional segment 1 comprises ten provisional points P1 to P10.

The positioning of its points P1 to P10 can be performed according to several options depending on the actual case to be dealt with. According to a first embodiment, field data can be used as a basis, in particular if one or more positioning points of the structure are known. This temporary segment 1 can also be positioned from existing map data, even if the latter could be improved or even lack precision. In the absence of data, it is also possible to place the points according to hypotheses on the location of the underground structure or hypotheses on its general shape.

The distance between the provisional points Pi can also vary, in particular depending on the geolocation precision required. Advantageously, the length of a sub-segment between two successive provisional points is between 5 and 15% of the expected length of the smallest dimension of the structure.

In this step of generating the provisional segment 1, generating a volume Vi around each provisional point Pi is also provided.

In the example of FIGS. 1 and 2, a single volume Vi including a point cloud has been represented. This volume Vi is disposed around the provisional point P4. That being said, the method generates a volume Vi around each provisional point Pi to allow the comparison steps described hereinafter.

In the example of FIGS. 1 and 2, this volume Vi around a point Pi is a cube, centered on Pi, the edge length of which corresponds to the length of the sub-segment between two successive points Pi. The set of volumes Vi thus forms a volume integrating the whole provisional segment 1. However, in other embodiments, volumes having different geometries and for example spheres around the points Pi can be provided. Also in other embodiments, it can be provided that the successive volumes overlap or, on the contrary, are not in contact.

With reference to FIG. 1, a simplified example of the distribution of the point cloud in a volume Vi is shown. According to an advantageous embodiment, the cloud points are distributed homogeneously in the volume Vi. However, other distribution modes are also conceivable such as a random distribution of points in the volume or increasing or decreasing concentrations or point densities around the provisional point Pi.

According to another embodiment, it is also provided that additional cloud points of a volume Vi are successively created during the simulation step and positioned in the volume Vi according to the scores of the cloud points simulated in the simulation step.

According to the invention, the method furthermore consists of carrying out a simulation step, for each point of each volume Vi, making it possible to calculate the simulated magnetic values (VMS) of the cloud points at all or some of the measuring points (Pm).

In the example of FIGS. 1 and 2, the magnetic value of each cloud point of each volume Vi is advantageously simulated at the set of measuring points Pm. However, this simulation requires a very large computing volume when the cloud points, on one hand, and the measuring points, on the other hand, are numerous. To limit the computing need, the magnetic value of each cloud point can also be simulated on only some of the measuring points Pm.

For example, the magnetic value (VMS) of a cloud point may be simulated only on the measuring points located at a distance less than a value D from said point. This limitation makes it possible to reduce computing needs while keeping the simulated magnetic values on the most significant measuring points Pm for the cloud point in question.

For example, it is also provided that the simulation step, for each point of each volume (Vi), makes it possible to calculate the simulated magnetic values (VMS) of the cloud points at a number N of measuring points from the set of measuring points and corresponding to the N measuring points closest to the point Pi of the volume (Vi) in question.

The simulation of the magnetic value of a point of the volume on all or some of the measuring points Pm is obtained by applying the Biot-Savart formula defining the magnetic field vector according to the set of infinitesimal pipeline section functions. The following formula is applied for the simulation of the simulated magnetic values with the variables listed in the table hereinafter:

$$\vec{B} ( \vec{r} ) = \frac{{μ}_{0}}{4 π} {∮}_{C} \frac{\vec{I} * d \vec{l} ⋀ ( \vec{r} - \vec{{r}^{′}} )}{{\vert \vec{r} - \vec{{r}^{′}} \vert}^{3}} \qquad [ Formula 1 ]$$

TABLE 1

| Variable | Meaning |
|---|---|
| \vec{B}(\vec{r}) | The magnetic field at the point in question |
| | of coordinates x, y, z. |
| $\frac{{μ}_{0}}{4 π}$ | A constant specific to the medium considered homogeneous. (Vacuum |
| | magnetic permeability). |
| \vec{I} | Direction of the direct current in the |
| | infinitesimal pipeline section. |
| d\vec{l} | Generatrix of the section in question |
| | including a cross-section length and a three- |
| | dimensional unit vector. |
| \vec{r} | Vector defining the oriented distance |
| | between the origin of the reference frame in |
| | question and the measuring point. |
| \vec{r ′} | Vector defining the oriented distance from |
| | the origin of the reference frame in question |
| | and the centre of the infinitesimal section. |
| [symbol] | Linear integral. |

This formula is then adapted to a computer simulation wherein infinitesimal pipeline sections are considered as portions of short distances. For each section, the following formula is obtained:

$$d \vec{B} ( \vec{r} ) = \frac{{μ}_{0}}{4 π} * \frac{\vec{I} * d \vec{l} ⋀ ( \vec{r} - \vec{{r}^{′}} )}{{\vert \vec{r} - \vec{{r}^{′}} \vert}^{3}} \qquad [ Formula 2 ]$$

$$where \vec{B} ( \vec{r} ) = {∮}_{C} d \vec{B} ( \vec{r} )$$

This second formula makes it possible to create a function to simulate the magnetic values at the measuring points (VMS) according to a section configuration for the cloud points.

When the simulation step is completed with the calculation of the simulated magnetic values (VMS), the method furthermore consists of performing a step of comparing the simulated magnetic values (VMS) of the cloud points of each volume Vi and the spatial magnetic data in order to assign a score to each cloud point of each volume Vi.

Advantageously, the score assigned to a point from a point cloud is dependent on the comparison between the simulated magnetic values (VMS) of this point at the measuring points Pm and the measured values (VM) at these measuring points Pm, i.e. the measured values (VM) obtained by the magnetometers, optionally corrected or processed so that they can be compared to the simulated magnetic values (VMS). As a general rule, the best score will be assigned to the point in the cloud for which the VMS are closest to the VMS of the measuring points.

At this level, different types of scoring algorithms can be envisaged and in particular algorithms using different convergence methods such as the methods listed in the table hereinafter:

TABLE 2

| Method | Explanation |
|---|---|
| Nelder-Mead | The Nelder-Mead method is an optimised numerical method for minimising non- |
| | linear problems where the derivative is not known. It is a heuristic search method |
| | that can converge to non-stationary points. |
| Powell | The Powell method is an iterative minimisation method for least squares score |
| | problems. This method uses gradient descent to search for parameter sets. |
| CG | The conjugate gradient method can be used to find the local minimum closest to |
| | minimisation by performing a multi-dimensional gradient descent. |
| BFGS | The Broyden-Fletcher-Goldfarb-Shanno method is an unconstrained non-linear |
| | minimisation method. This method is based on the analysis of successive |
| | gradients without Hessian matrix construction. This method assumes that the |
| | solution for the optimum is quadratic around the optimum. |
| L-BFGS-B | This BFGS-based method makes it possible to add a memory size limitation as |
| | well as constraints on minimisation parameters in order to guide the gradient |
| | descent and avoid solution divergence. |
| SLSQP | The SQP-based Sequential Least Squares Programming Optimisation method is a |
| | method for quasi-Newton problems to model the problem of local parameters as |
| | a quadratic hyperplane to find the overall minimum. |

Of course, other convergence methods may also be considered for calculating the score, according to the application, one of the minimisation methods will be selected and associated with a score calculation function.

The score calculation may be according to a first embodiment based on the errors at the measuring points between the actual measurement VM and the simulated value VMS. Among the different functions allowing this score calculation, a function from the non-limiting list of the following functions may be used: f (error sum of squares between VMS and VM), f (mean squared errors between VMS and VM), f (median squared errors between VMS and VM), f (90th percentile of squared errors between VMS and VM), f (maximum squared errors between VMS and VM).

The score calculation may also be, according to a second embodiment, based on the variation at the measuring points between the actual measurement and the simulated value. Among the different functions allowing this score calculation, a function from the non-limiting list of the following functions contained in the table hereinafter with their description may be used.

TABLE 3

| Function | Description |
|---|---|
| Log_pearson | log (2 − pearson(magₘₑₐₛᵤᵣₑ, mag_{synthetic})) This equation |
| | makes it possible to obtain a minimum when the correlation is |
| | maximum |
| Sum_square_diff_normalise | Σ(magₘₑₐₛᵤᵣₑ − normalise(mag_{synthetic}))² This equation |
| | looks at the normalised squared error, in order to remove the |
| | initialisation problem in C. |
| Log_spearman | log (2 − spearman(magₘₑₐₛᵤᵣₑ, mag_{synthetic})) This equation |
| | makes it possible to obtain a minimum when the correlation is |
| | maximum |
| Variance | var(magₘₑₐₛᵤᵣₑ − mag_{synthetic}²) Minimisation of variance |
| STD | std(magₘₑₐₛᵤᵣₑ − mag_{synthetic}²) Minimisation of standard deviation |

The choice of minimisation method and score calculation allows the operator to highlight various parameters such as the convergence speed to the point of the cloud to be selected, the convergence to an overall optimum, or the convergence precision when convergence stops.

When the comparison step is completed with cloud point score calculation, the method consists of furthermore performing a step of selecting, for each volume (Vi), a point in the cloud having the best score, the set of selected points Si replacing the set of provisional points Pi of the provisional segment 1.

With reference to FIG. 2, the definitive segment referenced 2 is shown. Compared to the provisional segment, only the point P1 is retained, the definitive segment 2 being disposed slightly below the provisional segment.

According to an advantageous embodiment of the invention, the selection step consists of retaining the cloud point having the best score and preventing generation of the magnetic map if a selected point Si of at least one of the sub-segments has an insufficient score compared to a predetermined score value.

This feature is particularly important as it makes it possible to prevent the generation of geolocation maps having aberrations or anomalies.

According to this feature, if the score is insufficient, which corresponds to excessive divergence between the simulated magnetic values (VMS) and the measured values (VM), different possibilities may be envisaged. According to a first option, the method generates an error message intended for the operator. The operator can then analyse the reasons for map generation failure and restart the method.

According to a second option, if a selected point Si has an insufficient score, the method resumes at the first step of generating a segment with other hypotheses and in particular a new set of magnetic data, or another numerical simulation model or another underground structure scenario, or another initial provisional segment positioning. This procedure can advantageously be repeated until a hypothesis makes it possible to obtain points Si with sufficient scores.

Of course, in the method according to the invention, it is not necessary to go through steps of displaying the positions of the measuring points Pm, the provisional segment 1 or even the definitive segment 2. However, these display steps can be provided as an alternative embodiment to improve the understanding of the results for the operator.

The method according to the invention makes it possible to determine the selected points Si by calculation and simulation. This determination of the points Si will make it possible to perform the step of creating a magnetic map containing all the selected points Si.

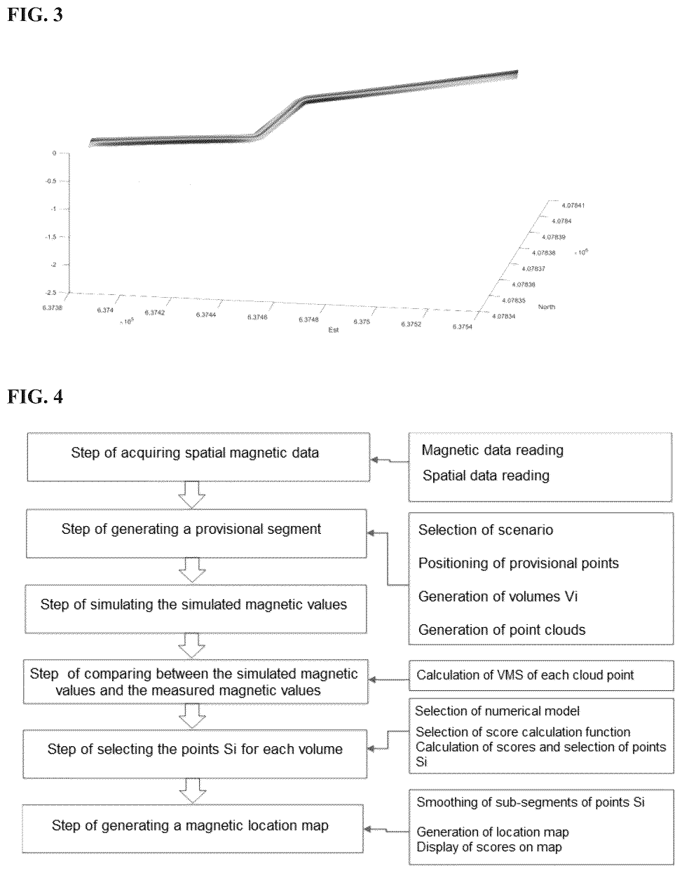

With reference to FIG. 3, an example of a magnetic map 4 according to the invention is thus shown.

In the example of FIG. 3, it can be seen that the segment corresponding to the structure has smoothed angles. According to an advantageous feature of the invention, during the step of creating the magnetic map 4, a smoothing step for limiting the angles between two successive sub-segments is provided. This step makes it possible to refine the general shape of the definitive segment to make it compatible with the expected general shape of the structure to be geolocated.

According to an advantageous embodiment, the magnetic creation step allows a display of areas of variable precision according to the scores of each sub-segment and/or the definitive segment 2 score. These different areas will allow an operator to quickly view the areas according to the estimated location precision. In the example of FIG. 3, the greyscale is used to identify the precision of one area compared to another. However, in other embodiments, the precisions of the areas may be indicated otherwise and for example by a colour code or numerical values.

With reference this time to FIG. 4, an example embodiment of the method is shown in diagram form. The different steps of the mapping method are summarised in the form of a diagram allowing the operation and advantages of the invention to be understood, in particular with respect to the prior art.

Of course, other features within the grasp of a person skilled in the art could also have been considered without for all that leaving the scope of the invention as defined in the following claims.

1. A mapping method for the status inspection and/or geolocation of an underground, semi-underground or submerged structure comprising a metallic or magnetic material, the method comprising:
acquiring spatial magnetic data obtained by magnetic sensors at different measuring points of the area to be inspected, after injecting a current onto the structure;
generating a provisional segment, including a set of provisional points, and a volume around each provisional point, the volume including a point cloud;
performing a simulation for each point of each volume, making it possible to calculate simulated magnetic values of the cloud points at all or some of the measuring points,
comparing the simulated magnetic values of the cloud points of each volume and magnetic values of the spatial magnetic data to assign a score to each cloud point of each volume,
selecting, for each volume, a point in the cloud having the best score, the set of selected points replacing the set of provisional points of the provisional segment,
creating a magnetic map containing the set of selected points.

2. The mapping method according to claim 1, wherein the volume around a provisional point is a cube, centered on the provisional point, an edge length of which corresponds to a length of the sub-segment between two successive provisional points.

3. The mapping method according to claim 1, wherein the cloud points are distributed homogeneously in the volume.

4. The mapping method according to claim 1, wherein the simulated magnetic value of a cloud point at a measuring point is obtained by applying the following formula:
$$d \vec{B} ( \vec{r} ) = \frac{{μ}_{0}}{4 π} * \frac{\vec{I} * d \vec{l} ⋀ ( \vec{r} - \vec{{r}^{′}} )}{{\vert \vec{r} - \vec{{r}^{′}} \vert}^{3}}$$
$$where \vec{B} ( \vec{r} ) = {∮}_{C} d \vec{B} ( \vec{r} )$$

5. The mapping method according to claim 1, wherein the score assigned to a point of a point cloud is dependent on the comparison between the simulated magnetic values of this point at the measuring points and the measured values at these measuring points.

6. The mapping method according to claim 5, wherein the calculation of score of a cloud point is based on the errors at the measuring points between the measured magnetic value and the simulated magnetic value.

7. The mapping method according to claim 5, wherein the calculation of the score of a cloud point is based on the variation at the measuring points between the measured magnetic value and the simulated magnetic value.

8. The mapping method according to claim 1, wherein the simulation, for each point of each volume, makes it possible to calculate the simulated magnetic values of the cloud points at a number N of measuring points from the set of measuring points and corresponding to the N measuring points closest to the point Pi of the volume in question.

9. The mapping method according to claim 1, wherein additional cloud points of a volume are successively created during the simulation and positioned in the volume according to the simulated scores of the cloud points.

10. The mapping method according to claim 1, wherein the selecting consists of retaining the cloud point having the best score and preventing generation of the magnetic map if a selected point of at least one of the sub-segments has an insufficient score compared to a predetermined score value.

11. The mapping method according to claim 1, wherein if a selected point has an insufficient score, the method resumes at the first step of generating a segment with a new set of magnetic data, or another numerical simulation model, another underground structure scenario, or another initial provisional segment positioning.

12. The mapping method according to claim 1, wherein the magnetic creation step allows a display of areas of variable precision according to the scores of each definitive sub-segment and/or the definitive segment score.

13. The mapping method according to claim 1, wherein it is provided that said creating includes a smoothing making it possible to limit the angles between two successive definitive sub-segments.

14. The mapping method according to claim 1, wherein the step of acquiring the spatial magnetic data comprises:
injecting a current into the structure, and
processing the signal, the electrical component of the signal emitted by the structure in response to the injection of the signal allowing comparison with the simulated magnetic values.

15. The mapping method according to claim 1, wherein the step of acquiring the spatial magnetic data comprises:
injecting an alternating current into the structure, and
processing magnetic measurements via a bandpass filter and a Hilbert filter.
